(19) United States
(12) Patent Application Publication
(10) Pub. No.: US 2006/0282491 A1
(43) Pub. Date: Dec. 14, 2006

(54) Method for countermeasuring by masking the accumulators in an electronic component while using a public key cryptographic algorithm

(75) Inventor: Marc Joye, Saint Zacharie (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/561,234

(22) PCT Filed: Jun. 17, 2004
(86) PCT No.: PCT/EP04/51144

§ 371 Date: Jul. 13, 2006

(30) Foreign Application Priority Data
Jun. 18, 2003 (FR) 0307379

(51) Int. Cl. G06F 7/00

(52) U.S. Cl. 708/492

(57) ABSTRACT

The invention relates to a method for countermeasuring in an electronic component while using a public key cryptographic algorithm. The invention is characterized in that the method comprises an exponentiation calculation with a left-to-right exponentiation algorithm y=gˆd, in which g and y are elements of the specified group G noted in a multiplicative manner and d is a predetermined number. The inventive method is also characterized by comprising a random selection step at the beginning of or during the execution of said exponentiation algorithm in a deterministic or probabilistic manner for masking the accumulator A.

The present invention relates to a countermeasure method for implementation in an electronic component implementing a public-key cryptography algorithm.

In the conventional secret-key cryptography model, two people who wish to communicate over a non-secure channel must first agree on a secret encryption key K. The encryption function and the decryption function use the same key K. The drawback of the secret-key encryption system is that said system requires prior communication of the secret key between the two people over a secure channel, before any encrypted message is sent over a non-secure channel. In practice, it is generally difficult to find a communications channel that is fully secure, especially if the two people are a long distance apart. The term “secure channel” is used to mean a channel for which it is impossible to know or to modify the information conveyed over said channel. Such a secure channel can be implemented by a cable interconnecting two terminals possessed by respective ones of said two people.

The concept of public-key cryptography was invented by Whitfield Diffie and Martin Hellman in 1976 (IEEE Transactions on Information Theory, volume 22, number 6, pages 644-654, 1976). Public-key cryptography makes it possible to solve the problem of distributing keys over a non-secure channel. Public-key cryptography is based on the difficulty of solving certain problems that are (assumed to be) computationally unfeasible. The problem considered by Diffie and Hellman is to solve the discrete logarithm problem in the multiplicative group of a finite field.

It is recalled that, in a finite field, the number of elements of the field is always expressed in the form q [symbol] n, where q is a prime number that is called the “characteristic” of the field and n is an integer number. A finite field possessing q [symbol] n elements is written GF(q [symbol] n). When the integer number n is equal to 1, the finite field is said to be “prime”. A field has two groups, namely a multiplicative group and an additive group. In the multiplicative group, the neutral element is written “1” and the group law is written in multiplicative notation by the symbol “·” and is called “multiplication”. Said law defines the exponentiation operation in the multiplicative group G: given that an element g belonging to G is an integer d, the result of the exponentiation of g by d is the element y such that y=g^{d}=g·g·g· . . . ·g (d times) in the group G.

Solving the discrete logarithm problem in the multiplicative group G of a finite field consists in determining whether there exists an integer d such that y=g [symbol] d in G, given two elements y and g belonging to G.

Thus, it is possible for two people to build a common key K. A person A chooses a random number a, computes the half-key Kₐ=g [symbol] a in G, and sends Kₐ to a person B. In the same way B chooses a random number b, computes the half-key K_{b}=g [symbol] b in G, and sends K_{b} to A. Then A computes K=K_{b} [symbol] a and B computes K=Kₐ [symbol] b. Remarkably, person A and person B are the only people who are capable of building the common key K=g [symbol] (ab).

In addition to such key exchange, public-key cryptography makes the following possible: data encryption, digital signature, authentication, or identification. Numerous cryptographic systems based on the discrete logarithm problem are presented in the “Handbook of Applied Cryptography” by Alfred Menezes, Paul van Oorschot, and Scott Vanstone, CRC Press, 1997. By way of example, mention can be made of El Gamal encryption or digital signature using the Digital Signature Algorithm (DSA).

Other groups have been considered for implementing systems analogous to cryptographic systems built in the multiplicative group of a finite field. In 1985, Victor Miller and Neal Koblitz independently proposed using elliptic curves in cryptographic systems. The advantage of cryptographic systems based on elliptic curves is that they provide security equivalent to the other cryptographic systems but with smaller key sizes. That saving in key size brings a reduction in memory needs and a reduction in computation time, thereby making the use of elliptic curves particularly well suited to applications of the smart card type.

It is recalled that an elliptic curve on a finite field GF(q [symbol] n) is the set of firstly the points (x,y) belonging to GF(q [symbol] n) verifying the following equation: Y [symbol] 2+a₁xy+a₃y=x [symbol] 3+a₂x [symbol] 2+a₄x+a₆, with a₁ in GF(q [symbol] n), and secondly the point at infinity 0. Any elliptic curve defined on a field can be expressed in this form.

The set of the points (x,y) and the point at infinity form an abelian group in which the point at infinity is the neutral element and in which the group operation is points addition, noted “+” and given by the well known rule of the secant and of the tangent (see, for example, “Elliptic Curve Public Key Cryptosystems” by Alfred Menezes, Kluwer, 1993). In that group, the (x,y) pair, where the x-axis and the y-axis are elements of the field GF(q [symbol] n), forms the affine co-ordinates of a point P of the elliptic curve.

Two methods exist for representing a point of an elliptic curve:
firstly, affine co-ordinates representation; in this method a point P of the elliptic curve is represented by its (x,y) co-ordinates; and
secondly, projective co-ordinates representation.

The advantage of projective co-ordinates representation is that it makes it possible to avoid divisions in the finite field, such divisions being the operations that are most costly in terms of computation time.

The projective co-ordinates representation that is in most common use is the Jacobian projective co-ordinates representation and it consists in representing an (x,y) affine co-ordinates point P on the elliptic curve by the (X,Y,Z) co-ordinates, such that x=X/Z [symbol] 2 and y=Y/Z [symbol] 3. The Jacobian representation of a point is not unique because the (X,Y,Z) triplet and the (λ [symbol] 2·X, λ [symbol] 3·Y, λ·Z) triplet represent the same point regardless of the non-zero element λ belonging to the finite field on which the elliptical curve is defined.

Another projective co-ordinates representation is the homogeneous projective co-ordinates representation and it consists in representing an (x,y) affine co-ordinates point P on the elliptic curve by the (X,Y,Z) co-ordinates, such that x=X/Z and y=Y/Z. The homogeneous representation of a point is not unique because the (X,Y,Z) triplet and the (λ·X, λ·Y, λ·Z) triplet represent the same point regardless of the non-zero element λ belonging to the finite field on which the elliptical curve is defined.

The points addition operation makes it possible to define an elliptic curve exponentiation operation: given a point P belonging to an elliptic curve, and an integer d, the result of the exponentiation of P by d is the point Q such that Q=d*P=P+P+ . . . +P (d times). When elliptic curves are used, in order to emphasize the additive notation, the exponentiation is also called “scalar multiplication”.

The security of elliptic-curve cryptographic algorithms is based on the difficulty of the discrete logarithm problem in the Group G formed by the points of an elliptic curve, said problem consisting, from points Q and P belonging to G, in finding an integer d such that Q=d*P, when such an integer exists.

Numerous cryptography algorithms exist that are based on the discrete logarithm problem. Thus, it is possible to implement algorithms providing authentication, confidentiality, integrity checking, and key exchange.

A property common to most cryptography algorithms based on the discrete logarithm problem in a group G is that they have, as a parameter, an element g belonging to that group. The private key is an integer d that is chosen randomly. The public key is an element such that y=g [symbol] d. Such cryptography algorithms generally involve an exponentiation in computing an element z=h [symbol] d, where d is the secret key and h is an element of the group G.

In the paragraph below, a description is given of an encryption algorithm based on the discrete logarithm problem in a group G, written in multiplicative notation. That scheme is analogous to the El Gamel encryption scheme. Let a group be G and an element in G be g. The encryption public key is y=g [symbol] d and the decryption private key is d. A message m is encrypted in the following manner:

The “encrypter”, i.e. the person who wishes to encrypt a message, chooses an integer k randomly and computes the elements h=g [symbol] k and z=y [symbol] k in the Group G, and c=R(z)⊕ m, where R is a function applying the elements of G to all of the messages and ⊕ designates the exclusive OR operator. The ciphertext corresponding to m is the pair (h,c).

The “decrypter”, i.e. the person who wishes to decrypt a message, who possesses the secret key d, decrypts m by computing:

z′=h [symbol] d=g [symbol] (k·d)=y [symbol] k and m=R(z′)⊕ c.

In order to perform the exponentiations necessary in the above-described computation methods, several algorithms exist:
the left-to-right binary exponentiation algorithm;
the left-to-right k-ary exponentiation algorithm;
the modified left-to-right k-ary exponentiation algorithm;
the left-to-right sliding-window exponentiation algorithm; and
the algorithm for exponentiation with signed-digit representation of the exponent.

Those algorithms are described in detail in Chapter 14 of the “Handbook of Applied Cryptography” by A. J. Menezes, P. C. van Oorschot, and S. A. Vanstone, CRC Press, 1997. This list is not exhaustive.

The simplest and most commonly used algorithm is the left-to-right binary exponentiation algorithm. The left-to-right binary exponentiation algorithm takes as input an element g of a group G and an exponent d. The exponent d is written d=(d(t), d(t−1), . . . ,d(0)), where (d(t),d(t−1), . . . ,d(0)) is the binary representation of d, where d(t) is the most significant bit and d(0) is the least significant bit. The algorithm returns as output the element y=g [symbol] d in the group G.

The left-to-right binary exponentiation algorithm comprises the following three steps:
1) Initialize the register A with the neutral element of G
2) For i from t down to 0, do the following:
   2a) Replace A with A [symbol] 2
   2b) If d(i)=1, then replace A with A·g
3) Return A.

The left-to-right k-ary exponentiation algorithm takes as input an element g of a group G and an exponent d written d=(d(t),d(t−1), . . . ,d(0)), where (d(t),d(t−1), . . . ,d(0)) is the k-ary representation of d, i.e. each digit d(i) of the representation of d is an integer lying in the range 0 to 2 [symbol] k−1 for an integer k≧1, where d(t) is the most significant digit and d(0) is the least significant digit. The algorithm returns as output the element y=g [symbol] d in the group G and comprises the following four steps:
1) Precomputation:
   (1a) Define g₁=g
   (1b) If k≧2, for i from 2 to (2 [symbol] k−1): compute gᵢ=d [symbol] i
2) Initialize the register A with the neutral element of G
(3) For i from t down to 0, do the following:
   (3a) Replace A with A [symbol] (2 [symbol] k)
   (3b) If d(i) is non-zero, replace A with A·gᵢ
4) Return A.

When k is equal to 1, it is observed that the left-to-right k-ary exponentiation algorithm is none other than the left-to-right binary exponentiation algorithm.

The left-to-right k-ary exponentiation algorithm can be adapted to take as input a signed-digit representation of the exponent d. The exponent d is given by the representation (d(t),d(t−1), . . . ,d(0)) in which each digit (d(i) is an integer lying in the range −(2 [symbol] k−1) to 2 [symbol] k−1 for an integer k≧1, where d(t) is the most significant digit and d(0) is the least significant digit. Step 3b of the preceding algorithm is then replaced with:
3b′) If d(i) is strictly positive, replace A with A·gᵢ; and if d(i) is strictly negative, replace A with A·(gᵢ) [symbol] (−1).

That adaptation is particularly advantageous when the inverses of the elements gᵢ, written (gᵢ) [symbol] (−1), are easy or low-cost to compute. This applies, for example, in the case of a group G of the points of an elliptic curve. When the inverses of the elements gᵢ are not easy or are too costly to compute, their values are precomputed.

The modified left-to-right k-ary exponentiation algorithm reduces the precomputations of the left-to-right k-ary exponentiation algorithm by computing only g [symbol] 2 and the odd powers of g when k≧2. It has the same inputs as the left-to-right k-ary exponentiation algorithm, and it returns as output the element y=g [symbol] d in the group G. It comprises the following four steps:
1) Precomputation:
   (1a) Define g₁=g and compute g₂=g [symbol] 2
   (1b) For i from 1 to (2 [symbol] (k−1)−1): compute g₂ᵢ₊₁=g [symbol] (2i+1)
2) Initialize the register A with the neutral element of G
(3) For i from t down to 0, do the following:
   (3a) If d(i)=0, replace A with A [symbol] (2 [symbol] k)
   (3b) If d(i) is non-zero, write d(i)=2 [symbol] v·u where u is odd and replace A with [A [symbol] (2 [symbol] (k−v))·gᵤ] [symbol] (2 [symbol] v)
4) Return A.

Like the modified left-to-right k-ary exponentiation algorithm, the left-to-right sliding-window exponentiation algorithm reduces not only the precomputations but also the mean number of multiplications in the group G. It takes as input an element g of a group G, an exponent d, written d=(d(t),d(t−1), . . . ,(d(0)), where (d(t),d(t−1), . . . ,d(0)) is the binary representation of d and an integer k>1 called the width of the window. It returns as output the element y=g [symbol] d in the group G and comprises the following four steps:
1) Precomputation:
   (1a) Define g₁=g and compute g₂=g [symbol] 2
   (1b) For i from 1 to (2 [symbol] (k−1)−1): compute g₂ᵢ₊₁=g [symbol] (2i+1)
2) Initialize the register A with the neutral element of G and initialize the counter i with the value t
(3) So long as i is positive or zero, do the following:
   (3a) If d(i)=0, replace A with A [symbol] 2 and replace i with i−1
   (3b) If d(i)=1, do the following
      3b-1) Find the longest binary chain or “bistring” d(i),d(i−1), . . . ,d(j) such that i−j+1≦k and d(j)=1
      3b-2) Define u as the integer having as a binary representation (d(i),d(i−1), . . . ,d(j))
      3b-3) Replace A with A [symbol] (2 [symbol] (i−j+1))·gᵤ and replace i with j−1
4) Return A.

The above-described exponentiation algorithms for computing y=g [symbol] d in the Group G and their many variants scan the exponent d from left to right, i.e. from the most significant position to the least significant position. Remarkably, two distinct types of operation can be observed:
the multiplications of the register A, called the “accumulator”, by itself; and
the multiplications of the register A by the constant value g or by one of the powers thereof gᵢ=g [symbol] i.

When g (or one of its powers gᵢ) has a particular structure, the multiplication of the accumulator A by g in the group G (or one of its powers gᵢ) can be substantially faster than the multiplication of two arbitrary elements of G.

In particular, when the group G is the multiplicative group of the prime field GF(q) and when g (or one of its powers gi) is represented as a single-precision integer, multi-precision computation of A·g (or of A·gi) in G can be performed in linear time. For example, if g is equal to 2, the multiplication of A by g=2 comes down to adding A with itself in the group G: A·2=A+A.

The above-described exponentiation algorithms are given in multiplicative notation; in other words, the group law of the group G is written “·” (multiplication). Those algorithms can be given in additive notation by replacing the multiplications with additions; in other words, the group law of the group G is written “+” (addition). This applies, for example, for the group of the points of an elliptic curve which is usually given in additive form. In which case, the case of Q=d*P on an elliptic curve can be computed by any one of the above-described algorithms by replacing the multiplication operation with addition of points on said elliptic curve. Similarly and remarkably, two distinct types of operation are observed:
the additions of the register A, called the “accumulator”, by itself; and
the additions of the register A by the constant value P or by one of its multiples Pᵢ=i*P.

When the point P (or one of its multiples Pᵢ) has a particular structure, the addition of the accumulator A by P (or by one of its multiples Pᵢ) can be substantially faster than addition of two arbitrary points on an elliptic curve. In particular, if the point P is represented in projective co-ordinates (in Jacobian or homogeneous manner) by P=(X,Y,Z) with the Z co-ordinate equal to 1, the number of operations for computing the addition of the points A and P in projective co-ordinates is small.

It has appeared that, on a smart card, implementing a public-key cryptography algorithm based the discrete logarithm problem is vulnerable to attacks consisting in differentially analyzing a physical magnitude making it possible to retrieve the secret key. Such attacks are known as “Differential Power Analysis” (“DPA”) attacks and they were revealed in particular by Paul Kocher (Advances in Cryptology—CRYPTO '99, volume 1966 of Lecture Notes in Computer Science, pages 388-397, Springer-Verlag, 1999). Among the physical magnitudes that can be used for such purposes, mention can be made of current consumption, electromagnetic field, etc. Such attacks are based on the fact that handling a bit, i.e. processing a bit by means of a particular instruction, has a particular imprint on the physical magnitude in question, depending on its value.

In particular, when an instruction handles data having a particular bit that is constant, with it being possible for the values of the other bits to vary, analysis of current consumption due to the instruction shows that the mean consumption of the instruction is not the same depending on whether the particular bit takes the value 0 or 1. A DPA-type attack thus makes it possible to obtain additional information on the intermediate data handled by the microprocessor of the electronic component during execution of a cryptography algorithm. Said additional information can, in certain cases, make it possible to reveal private parameters of the cryptography algorithm, making the cryptographic system vulnerable.

An effective parry to attacks of the DPA type is to make the inputs of the exponentiation algorithm used to compute y=g [symbol] d random. In other words, the exponent d and/or the element g is/are made random. In additive notation, in the computation of Q=d*P, the exponent d and/or the element P is/are made random.

Countermeasure methods applying that principle are known. Such countermeasure methods are, in particular, described in an article by Jean-Sabastien Coron (Cryptographic Hardware and Embedded Systems, volume 1717 of Lecture Notes in Computer Science, pages 292-302, Springer-Verlag, 1999)

In particular, in that article, a countermeasure method consists in masking the point P of the group of the points of an elliptic curve defined on the field GF(q [symbol] n) by using projective co-ordinates of said point, defined randomly. In the above-mentioned article, a non-zero random number λ is thus drawn from GF(q [symbol] n) and the point P=(x,y) is represented by projective co-ordinates that are a function of said random number, e.g. in the form P=(λ [symbol] 2·x,λ [symbol] 3·y,λ) in Jacobian representation, or P=(λ·x,λ·y,λ) in homogeneous representation. The exponentiation algorithm is applied to these co-ordinates. A representation is obtained of the point Q in projective co-ordinates, from which the affine co-ordinates of the point are deduced (computed).

Another countermeasure method known to the person skilled in the art for masking the element g of the multiplicative group G of a finite field GF(q [symbol] n) consists in representing said element in an extension of GF(q [symbol] n), in random manner. For example, in the case of a prime field GF(q), an extension of GF(q) is given by the ring R=Z(qk) obtained by taking the quotient of the ring of integers Z by the ring qkZ for a given integer k. A random number λ is then drawn from the ring Z/(k) and the element g is represented by g*=g+λ·q. The exponentiation algorithm applies to the element g* in R and a representation of the element y*=(g*) [symbol] d in R is obtained, from which representation the value of y=g [symbol] d in G is deduced (computed) by reducing y* modulo q.

That countermeasure method also applies in the case of an element g of the multiplicative group G of a finite field GF(q [symbol] n) where n>1. If the field GF(q [symbol] n) is represented as the quotient of the polynomial ring GF(q)[X] by an irreducible polynomial p of degree n on GF(q), then an extension of GF(q [symbol] n) is given by the ring R=GF(q)[X]/(p·k) obtained by taking the quotient of the polynomial ring GF(q)[X] by the product of the polynomials p and k with k given. A random polynomial λ(X) is then drawn from the ring GF[X]/(k) and the element g is represented by g*=g+λ·p. The exponentiation algorithm is applied to the element g* in R and a representation of the element y*=(g*) [symbol] d in R is obtained, from which representation the value of y=g [symbol] d in G is deduced (computed) by reducing y* modulo p(X).

The drawback with all of the above-described methods making g or P random is that if the element g (or P) of the group G is made random in the computation of y=g [symbol] d (or Q=d*P), then the particular structure of g (or P) can no longer be used to accelerate said computation.

An object of the present invention is to provide a countermeasure method, in particular for implementing a countermeasure against DPA-type attacks.

Another object of the invention is to provide a countermeasure method that is easy to implement.

Compared with known countermeasure methods, the method proposed offers the advantage of being faster for protecting the evaluation of y=g [symbol] d in a group G written in multiplicative notation (or the evaluation of Q=d*P if the group is written in additive notation) when the exponentiation algorithm used for this computation is of the left-to-right type and when g (or P) has a particular structure; since left-to-right exponentiation algorithms have the remarkable property of having multiplication operations for multiplication of the accumulator A by the constant value g or by one of its powers gᵢ=g [symbol] i (or addition operations for addition of the accumulator A by the constant value P or by one of its multiples Pᵢ=i*P).

The basic idea of the invention is to make the accumulator A random in the left-to-right exponentiation algorithm used. This masking method can take place at the start of the algorithm or indeed deterministically or probabilistically during execution of the algorithm. Thus, the computation of y=g [symbol] d in the group G written in multiplicative notation (or Q=d*P if the group G is written in multiplicative notation) is made random without the structure of the element g (or P) or one of its powers gᵢ=g [symbol] i (or one of its multiples Pᵢ=i*P) being degraded.

The invention provides a countermeasure method for implementation in an electronic component implementing a public-key cryptography algorithm comprising exponentiation computation, with a left-to-right type exponentiation algorithm, of the type y=g [symbol] d, where g and y are elements of the determined group G written in multiplicative notation, and d is a predetermined number, said countermeasure method being characterized in that it includes a random draw step, at the start of or during execution of said exponentiation algorithm in deterministic or in probabilistic manner, so as to mask the accumulator A so that the structure of the element g or of one of the powers thereof gᵢ=g [symbol] i is not degraded. This method applies in the same way if the group G is written in additive notation.

Other characteristics and advantages of the invention are presented in the following descriptions, given with reference to particular implementations.

It is explained above that the simplest exponentiation algorithm in a group G is the left-to-right binary exponentiation algorithm, and that this type of algorithm is more effective when the element of G that is input has a particular structure. In addition, most of the cryptographic systems whose security is based on the discrete logarithm problem are built in the multiplicative group of a finite field GF(q) with q prime or in the group of the points of an elliptic curve defined on a finite field.

Let G be the multiplicative group of a finite field GF(q), where q is prime, and let a left-to-right binary exponentiation algorithm take as input an element g of G represented as a single-precision integer and an exponent d given by the binary representation (d(t),d(t−1), . . . ,d(0)), and return as output the element y=g [symbol] d in the group G. In the invention, the accumulator of said exponentiation algorithm is masked randomly. Thus, a countermeasure method of the invention applied to the multiplicative group G of a prime field GF(q) can be written as follows:
1) Determine an integer k defining the security of the masking
2) Initialize the accumulator A with the integer 1
3) For i from t down to 0, do the following:
3a) Draw a random integer λ lying in the range 0 to k−1 and replace the accumulator A with A+λ·q (modulo k·q)
3b) Replace A with A [symbol] 2 (modulo k·q)
3c) If d(i)=1, replace A with A·g (modulo k·q)
4) Return A (modulo q).

Typically, the security parameter k is set at 32 or 64 bits. Remarkably, in step 3c, the multiplication takes place with the integer g represented as a single-precision integer.

Preferably, the masking of the accumulator A in step 3a takes place only at the start of the exponentiation. The following countermeasure method is thus obtained:
1) Determine an integer k defining the security of the masking
2) Draw a random integer λ lying in the range 0 to k−1 and initialize the accumulator A with the integer 1+λ·q (modulo k·q)
3) For i from t−1 down to 0, do the following:
3a) Replace A with A [symbol] 2 (modulo k·q)
3b) If d(i)=1, replace A with A·g (modulo k·q)
4) Return A (modulo q).

Remarkably, in step 3b, the multiplication takes place with the integer g represented in single-precision manner.

Another advantageous application of the invention concerns exponentiation in the group G of the points of an elliptic curve defined on a finite field GF(qˆn). In said group G, written in additive notation, the inversion of a point P, written −P, is a low-cost operation so that it is advantageous to replace the left-to-right binary exponentiation algorithm with its signed-digit version as explained in an article by François Morain and Jorge Olivos (Theoretical Informatics and Applications, volume 24, pages 531-543, 1990). Thus, let G be the group of the points of an elliptic curve defined on a finite field GF(q [symbol] n), and let a left-to-right binary signed-digit exponentiation algorithm take as input a point P represented in affine co-ordinates by P=(x,y) and an exponent d given by the binary signed-digit representation d(t+1),d(t), . . . ,d(0)) where d(i)=0, 1 or −1 for 0≦i≦t and d(t+1)=1, and return as output the point Q=d*P in the group G in affine co-ordinates. In the invention, the accumulator of said exponentiation algorithm is a triplet of values in GF(q [symbol] n) and is masked randomly. Thus, a countermeasure method of the invention applied to the group G of the points of an elliptic curve defined on a finite field GF(q [symbol] n) can be written as follows:
1) Initialize the accumulator A=(Aₓ,A_{y},A_{z}) with the (x,y,1) triplet
2) For i from t down to 0, do the following:
2a) Draw a random non-zero element λ from GF(q [symbol] n) and replace the accumulator A=(Aₓ,A_{y},A_{z}) with (λ [symbol] 2·Aₓ,λ [symbol] 3·A_{y},λ·A_{z})
2b) Replace A=(Aₓ,A_{y},A_{z}) with 2*A=(Aₓ,A_{y},A_{z}) in Jacobian representation, on the elliptic curve
2c) If d(i) is non-zero, replace A=(Aₓ,A_{y},A_{z}) with (Aₓ,A_{y},A_{z})+d(i)*(x,y,1) in Jacobian representation on the elliptic curve
3) If A_{z}=0, return the point at infinity; otherwise return (Aₓ/(A_{z}) [symbol] 2, A_{y}/(A_{z}) [symbol] 3).

Remarkably, in step 2c, the addition on the elliptic curve takes place with the point P=(x,y,1) whose Z co-ordinate is equal to 1.

Preferably, the masking of the accumulator A in step 2a takes place at the start only of the exponentiation. The following countermeasure method is thus obtained:
1) Draw a non-zero random element λ from GF(q [symbol] n) and initialize the accumulator A=(Aₓ,A_{y},A_{z}) with the (λ [symbol] 2·x,λ [symbol] 3·y,λ) triplet
2) For i from t down to 0, do the following:
2a) Replace A=(Aₓ,A_{y},A_{z}) with 2*A=(Aₓ,A_{y},A_{z}) in Jacobian representation, on the elliptic curve
2b) If d(i) is non-zero, replace A=(Aₓ,A_{y},A_{z}) with (Aₓ,A_{y},A_{z})+d(i)*(x,y,1) in Jacobian representation on the elliptic curve
3) If A_{z}=0, return the point at infinity;

Otherwise return (Aₓ/(A_{z}) [symbol] 2, A_{y}/(A_{z}) [symbol] 3).

Remarkably, in step 2b, the addition on the elliptic curve takes place with the point P=(x,y,1) whose Z co-ordinate is equal to 1.

If the points of the elliptic curve are represented homogeneously, the two above-described countermeasure methods respectively become:
1) Initialize the accumulator A=(Aₓ,A_{y},A_{Z}) with the (x,y,1) triplet
2) For i from t down to 0, do the following:
2a) Draw a random non-zero element λ from GF(q [symbol] n) and replace the accumulator A=(Aₓ,A_{y},A_{Z}) with (λ·Aₓ,λ·A_{y},λ·A_{z})
2b) Replace A=(Aₓ,A_{y},A_{z}) with 2*A=(Aₓ,A_{y},A_{z}) in homogeneous representation, on the elliptic curve
2c) If d(i) is non-zero, replace A=(Aₓ,A_{y},A_{z}) with (Aₓ,A_{y},A_{z})+d(i)*(x,y,1) in homogeneous representation on the elliptic curve
3) If A_{z}=0, return the point at infinity; otherwise return (Aₓ/A_{z}, A_{y}/A_{z}).

Remarkably, in step 2c, the addition on the elliptic curve takes place with the point P=(x,y,1) whose Z co-ordinate is equal to 1.
1) Draw a non-zero random element λ from GF(qˆn) and initialize the accumulator A=(Aₓ,A_{y},A_{z}) with the (λ·x,λ·y,λ) triplet
2) For i from t down to 0, do the following:
2a) Replace A=(Aₓ,A_{y}/A_{z}) with 2*A=(Aₓ,A_{y},A_{z}) in homogeneous representation, on the elliptic curve
2b) If d(i) is non-zero, replace A=(Aₓ,A_{y},A_{z}) with (Aₓ,A_{y},A_{z})+d(i)*(x,y,1) in homogeneous representation on the elliptic curve
3) If A_{z}=0, return the point at infinity; otherwise return (Aₓ/A_{z}, A_{y}/A_{z}).

Remarkably, in step 2b, the addition on the elliptic curve takes place with the point P=(x,y,1) whose Z co-ordinate is equal to 1.

In general, the countermeasure method of the invention is applicable to any exponentiation algorithm of the left-to-right type in a group G, written in multiplicative notation or in additive notation.

1. A countermeasure method executed in an electronic component implementing a public-key cryptography algorithm that employs exponentiation computation, with a left-to-right type exponentiation algorithm, of the type y=gˆd, where g and y are elements of a determined group G written in multiplicative notation, and d is a predetermined number, said countermeasure method including a random draw step, at the start of or during execution of said exponentiation algorithm in deterministic or in probabilistic manner, to mask an accumulator A.

2. A countermeasure method according to claim 1, wherein the group G is written in additive notation.

3. A countermeasure method according to claim 1, wherein the group G is the multiplicative group of a finite field written GF(qˆn), where n is an integer.

4. A countermeasure method according to claim 3, wherein the integer n is equal to 1: n=1.

5. A countermeasure method according to claim 4, comprising the following steps:
1) Determine an integer k defining the security of the masking and designate d by the binary representation (d(t), d(t−1), . . . , d(0))
2) Initialize the accumulator A with the integer 1
3) For i from t down to 0, do the following:
3a) Draw a random λ lying in the range 0 to k−1 and replace the accumulator A with A+λ·q (modulo k·q)
3b) Replace A with Aˆ2 (modulo k·q)
3c) If d(i)=1, replace A with A·g (modulo k·q)
4) Return A (modulo q).

6. A countermeasure method according to claim 4, comprising the following steps:
1) Determine an integer k defining the security of the masking, and designate d by the binary representation (d(t), d(t−1), . . . , d(0))
2) Draw a random λ lying in the range 0 to k−1 and initialize the accumulator A with the integer 1+k·q (modulo k·q)
3) For i from t−1 down to 0, do the following:
3a) Replace A with A [symbol] 2 (modulo k·q)
3b) If d(i)=1, replace A with A·g (modulo k·q)
4) Return A (modulo q).

7. A countermeasure method according to claim 2, wherein the exponentiation algorithm applies to the group G of the points of an elliptic curve defined on the finite field GF(q [symbol] n).

8. A countermeasure method according to claim 7, comprising the following steps:
1) Initialize the accumulator A=(Aₓ,A_{y},A_{z}) with the (x,y,1) triplet and designate d by the binary signed-digit representation (d(t+1), d(t), . . . , d(0)) with d(t+1)=1
2) For i from t down to 0, do the following:
2a) Draw a random non-zero element λ from GF(q [symbol] n) and replace the accumulator A=(Aₓ,A_{y},A_{z}) with (λ [symbol] 2·Aₓ, λ [symbol] 3·A_{y}, λ·A_{z})
2b) Replace A=(Aₓ,A_{y},A_{z}) with 2*A=(Aₓ,A_{y},A_{z}) in Jacobian representation, on the elliptic curve
2c) If d(i) is non-zero, replace A=(Aₓ,A_{y},A_{z}) with (Aₓ,A_{y},A_{z})+d(i)*(x)y,1) in Jacobian representation on the elliptic curve
3) If A_{z}=0, return the point at infinity; otherwise return (Aₓ/(A_{z}) [symbol] 2, A_{y}/(A_{z}) [symbol] 3).

9. A countermeasure method according to claim 7, comprising the following steps:
1) Draw a non-zero random element λ from GF(q [symbol] n) and initialize the accumulator A=(Aₓ,A_{y},A_{z}) with the (λ [symbol] 2·x, λ [symbol] 3·y, λ) triplet and designate d by the binary signed-digit representation (d(t+1), d(t), . . . , d(0)) with d(t+1)=1
2) For i from t down to 0, do the following:
2a) Replace A=(Aₓ,A_{y},A_{z}) with 2*A=(Aₓ,A_{y},A_{z}) in Jacobian representation, on the elliptic curve
2b) If d(i) is non-zero, replace A=(Aₓ,A_{y},A_{z}) with (Aₓ,A_{y},A_{z})+d(i)*(x,y,1) in Jacobian representation on the elliptic curve
3) If A_{z}=0, return the point at infinity; otherwise return (Aₓ/(A_{z}) [symbol] 2, A_{y}/(A_{z}) [symbol] 3).

10. A countermeasure method according to claim 7, comprising the following steps:
1) Initialize the accumulator A=(Aₓ,A_{y},A_{z}) with the (x,y,1) triplet and designate d by the binary signed-digit representation (d(t+1), d(t), . . . , d(0)) with d(t+1)=1
2) For i from t down to 0, do the following:
2a) Draw a random non-zero element λ from GF(q [symbol] n) and replace the accumulator A=(Aₓ,A_{y},A_{z}) with (λ·Aₓ, λ·A_{y}, λ·A_{z})
2b) Replace A=(Aₓ,A_{y},A_{z}) with 2*A=(Aₓ,A_{y},A_{z}) in homogeneous representation, on the elliptic curve
2c) If d(i) is non-zero, replace A=(Aₓ,A_{y},A_{z}) with (Aₓ,A_{y},A_{z})+d(i)*(x,y,1) in homogeneous representation on the elliptic curve
3) If A_{z}=0, return the point at infinity; otherwise return (Aₓ/A_{z}, A_{y}/A_{z}).

11. A countermeasure method according to claim 7, comprising the following steps:
1) Draw a non-zero random element λ from GF(q [symbol] n) and initialize the accumulator A=(Aₓ,A_{y},A_{z}) with the (λ·x, λ·y, λ) triplet and give d by the binary signed-digit representation (d(t+1), d(t), . . . , d(0)) with d(t+1)=1
2) For i from t down to 0, do the following:
2a) Replace A=(Aₓ,A_{y},A_{z}) with 2*A=(Aₓ,A_{y},A_{z}) in homogeneous representation, on the elliptic curve
2b) If d(i) is non-zero, replace A=(Aₓ,A_{y},A_{z}) with (Aₓ,A_{y},A_{z})+d(i)*(x,y,1) in homogeneous representation on the elliptic curve
3) If A_{z}=0, return the point at infinity; otherwise return (Aₓ/A_{z}, A_{y}/A_{z}).

12. An electronic component using the countermeasure method according to claim 1.
